(19) United States
(12) Patent Application Publication
(10) Pub. No.: US 2025/0150016 A1
(43) Pub. Date: May 8, 2025

(54) Smart Coils for an Electric Motor

(71) Applicants: University of Kentucky Research Foundation, Lexington, KY (US); Kansas State University Research Foundation, Manhattan, KS (US)

(72) Inventors: Behrooz Mirafzal, Manhattan, KS (US); JiangBiao He, Lexington, KY (US); Fariba Fateh, Manhattan, KS (US)

(21) Appl. No.: 18/835,864

(22) PCT Filed: Feb. 7, 2023
(86) PCT No.: PCT/US2023/062120

§ 371 Date: Aug. 5, 2024

Related U.S. Application Data
(60) Provisional application No. 63/267,641, filed on Feb. 7, 2022.

(51) Int. Cl. H02P 29/024

(52) U.S. Cl. CPC H02P 29/0241

(57) ABSTRACT

The disclosed electric motor includes a rotor, stator winding, cable, and motor controller. The rotor is configured to be coupled to a mechanical load. The stator winding is configured, when energized, to cause the rotor to turn. The stator winding includes an inductive coil configured to be energized with a first phase AC voltage. The stator winding includes an adaptive impedance circuit connected in parallel with the inductive coil. The circuit includes an impedance and a WBG transistor connected in series with the impedance. The WBG transistor is configured to close when an overvoltage is detected. The cable includes at least one conductor connected to the stator winding. The motor controller is configured to supply a multi-phase AC voltage to the stator winding through the cable.

### CROSS-REFERENCE TO RELATED APPLICATIONS

This application claims priority to U.S. Provisional Patent Application No. 63/267,641 titled “Smart Coils for an Electric Motor,” filed on Feb. 7, 2022, the entire contents of which are hereby incorporated herein by reference.

### FEDERAL FUNDING STATEMENT

This invention was made with government support under Grant No. 2135544 awarded by National Science Foundation and Grant No. 2135543 awarded by National Science Foundation. The government has certain rights in the invention.

### FIELD OF THE INVENTION

The field of the disclosure relates generally to electric motors and, more specifically, adjustable speed motors controlled by a switched drive, or inverter.

### BACKGROUND OF THE INVENTION

The emergence of wide-bandgap (WBG) semiconductor switches unlocks improvements in energy efficiency and power density previously unachievable in variable speed drives for electric motors. WBG semiconductor switches, such as, for example, Silicon Carbide (SiC) metal-oxide semiconductor field effect transistors (MOSFET) or Gallium Nitride (GaN) transistors can operate at very high switching frequencies compared to traditional semiconductor power switches, e.g., power MOSFETs or insulated gate bipolar transistors (IGBT), while maintaining low conduction losses. Traditional power semiconductors exhibit increased switching losses at high switching frequencies, reducing efficiency and introducing a need for thermal management systems. Although the high-frequency switching in WBG semiconductor switches boosts efficiency and reduces the need for bulky passive components and thermal management systems, the high-frequency switching itself can result in damaging surge voltages and insulation breakdown on motor components, e.g., motor windings.

At least some variable speed electric motors are operated, or driven, by a variable speed drive, or inverter, supplied by a direct current (DC) bus. The variable speed drive generates one or more phases of alternating current (AC) for energizing stator windings of the electric motor. There is typically at least a small length of cabling, or electrical conductors, through which the AC is delivered to the stator windings. In certain implementations, for example, in propulsion systems, the variable speed drive may be remote from the electric motor, thus requiring a greater length of cabling to deliver the AC. As the length of cabling increases, the system can experience voltage reflected waves and transient overvoltage, particularly where impedance discontinuities exist. The impedances of the various components supplying AC to the stator windings are often not precisely matched. Traditional variable speed drives switching at relatively low frequencies result in few transmission line effects along the conduction path between the variable speed drive and the stator windings. However, a variable speed drive utilizing WBG semiconductor switches operating, for example, at five to ten times greater frequency can introduce significant voltage reflections and resonance due to high dv/dt performance. If unmitigated, the voltage reflections and resonance can manifest as damaging surge voltages at the variable speed drive output terminals, on the stator windings, or anywhere in between.

### BRIEF DESCRIPTION

In one aspect, the disclosed electric motor includes a rotor, stator winding, cable, and motor controller. The rotor is configured to be coupled to a mechanical load. The stator winding is configured, when energized, to cause the rotor to turn. The stator winding includes an inductive coil configured to be energized with a first phase AC voltage. The stator winding includes an adaptive impedance circuit connected in parallel with the inductive coil. The circuit includes an impedance and a WBG transistor connected in series with the impedance. The WBG transistor is configured to close when an overvoltage is detected. The cable includes at least one conductor connected to the stator winding. The motor controller is configured to supply a multi-phase AC voltage to the stator winding through the cable.

In another aspect, an adaptive impedance circuit for connection to at least one inductive coil of a stator winding for an electric motor is disclosed. The adaptive impedance circuit includes an impedance including at least a capacitance, and a first WBG transistor connected in series with the impedance. The WBG transistor is configured to close when an overvoltage is detected. Closing the first WBG transistor connects the impedance in parallel to the at least one inductive coil.

In yet another aspect, a method of operating an electric motor is disclosed. The method includes supplying a direct current (DC) voltage to an inverter. The method includes generating a multi-phase alternating current (AC) voltage for supply, via a cable, to a stator winding of the electric motor, thereby electromagnetically coupling the stator winding to a rotor and causing the rotor to turn. The method includes detecting an overvoltage. The method includes enabling an adaptive impedance circuit coupled in parallel to at least one coil of the stator winding in response to detecting the overvoltage.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an example electric motor drive system;

FIG. 2 is a graph illustrating the variations of electric motor surge voltage over the cable length;

FIG. 3 is a schematic diagram of a stator winding with adaptive impedance circuit;

FIG. 4 is a schematic diagram of the stator winding shown in FIG. 3 with another embodiment of an adaptive impedance circuit; and

FIG. 5 is a flow diagram of an example method of operating an electric motor.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed electric motors include windings having adaptive impedance circuits to enable attenuating excess voltage accumulating within the electric motor, for example, due to high dv/dt performance of WBG switching devices in variable speed drives. Excess voltages may develop at output terminals of the variable speed drive, on the stator windings, or the cabling connecting the variable speed drive to the stator windings as a result of reflections and resonance of high frequency switching noise, or “ringing,” associated with the WBG switching devices. Systems are often designed to minimize cable lengths to mitigate these effects. The disclosed adaptive impedance circuit, or adaptive winding impedance circuit, can be integrated within one or more stator windings within a given phase or, more specifically, within a first stator-phase slot for the electric motor, e.g., on each phase. For example, in one embodiment, the disclosed adaptive impedance circuit is integrated within a first and second stator-phase slot for the electric motor on each phase. When excess voltage is detected on a particular AC phase, an adaptive impedance circuit corresponding to the phase is enabled, changing the stator winding impedance for a period of time. Alternatively, the adaptive impedance circuit can be integrated within another stator-phase slot; however, due to uneven voltage distribution among the coils within a given phase, the greatest stress of overvoltage is experienced at the first coil in each phase, followed by the second coil, and so on.

The adaptive impedance circuit is coupled in parallel with a stator winding and includes transistors, such as, for example, WBG Silicon Carbide (SiC) or Gallium Nitride (GaN) transistors coupled in series with one or more capacitors, such as, for example, ceramic capacitors that can withstand high temperature up to 125 degrees Celsius or higher, or other similarly capable film capacitors, or electrolyte capacitors. More generally, the adaptive impedance circuit may utilize other WBG transistors or capacitors having a small footprint and high heat tolerance (e.g., up to 175 degrees Celsius) to enable their positioning within a stator slot. In at least some embodiments, the adaptive impedance circuit includes antiparallel transistors controlled by a driver circuit to open and close the adaptive impedance circuit. When closed, the winding impedance is capacitive for a period of time. When open, the winding impedance is inductive. The driver circuit, e.g., an analog driver circuit, opens and closes the transistors based on a measured voltage, e.g., at the variable speed drive output terminals, on the cables, or at the AC input terminals for the stator windings. The analog driver circuit may include, for example, a microcontroller and an analog gate driver device, or other suitable components. The driver circuit may be configured to enable, i.e., close, the adaptive impedance circuit at any predetermined voltage threshold, absolute or relative. For example, the driver circuit may close the transistors when a measured voltage on the variable speed drive output terminals exceeds 600 Volts, 800 Volts, 1000 Volts, 1200 Volts, or 3300 Volts. Alternatively, the driver circuit may close the transistors when the measured voltage exceeds a multiple of a DC bus voltage supplied to the variable speed drive. For example, the driver circuit may close the transistors when the measured voltage exceeds 1.5× (i.e., 1.5 times) the DC bus voltage, or another suitable multiple of the DC bus voltage.

The driver circuit for the disclosed adaptive impedance circuit is energized independent of the stator windings for a given phase. For example, in certain embodiments, the driver circuits may be powered by the DC bus or AC power supplied to the electric motor. The driver circuit may also include a voltage regulation circuit to step-down, for example, the DC bus voltage to a low voltage DC supply for analog components. Alternatively, the driver circuit could be powered by a battery or other external power source.

The disclosed electric motors enable the benefits of WBG switching devices in electric motors, including increased power density, increased efficiency, and improved reliability, which are all important factors in electric motors and power electronics for propulsion systems and other safety-critical applications, e.g., electric aircraft, electric shipboards, and electric vehicles. Moreover, the disclosed electric motors avoid bulky and less efficient alternatives for mitigating surge voltages, including, for example, passive filters (e.g., RLC filters or sine wave filters) or over-rated, or over-sized, conductor insulation on motor components, such as stator windings. Such alternatives generally (a) compromise energy efficiency and power density gains from WBG variable speed drives, and (b) often increase fabrication cost and reduce power density for the electric motor. The disclosed adaptive impedance circuit engages only when surge voltages develop within the electric motor, thereby reducing forward conduction losses and eliminating the need for additional cooling or thermal management systems for the WBG switching devices.

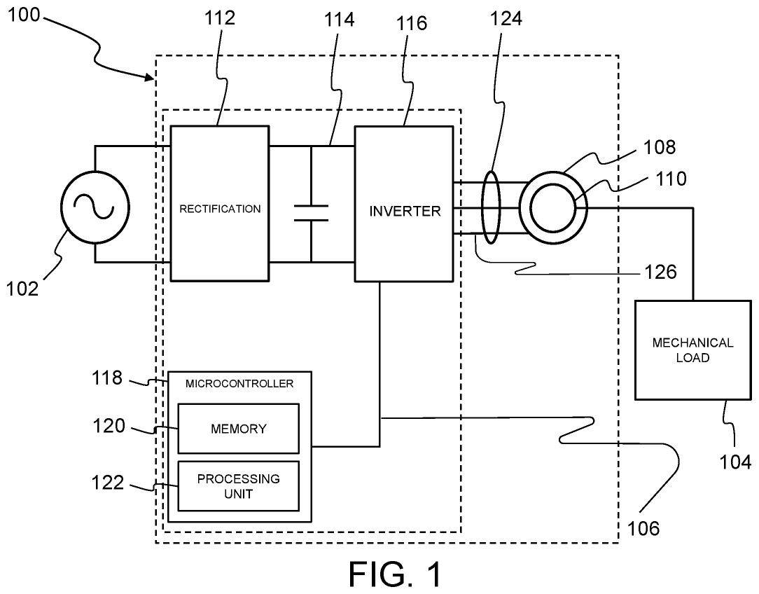

FIG. 1 is a schematic diagram of an example electric motor drive system 100. Electric motor drive system 100 utilizes an AC power supply 102 and turns, or operates, a mechanical load 104. Electric motor drive system 100 includes a motor controller 106 (also referred to as a variable speed drive) for controlling the generation of one or more phases of AC at a determined voltage and frequency for application to stator windings 108. Upon energizing stator windings 108, a rotor 110 electromagnetically coupled to stator windings 108 turns. Rotor 110 is coupled to mechanical load 104 and turns mechanical load 104.

Electric motor drive system 100 and, more specifically, motor controller 106 includes various power electronics for conditioning AC power, e.g., line frequency 230 volt or 480 volt, received from AC power supply 102. The power electronics may include, for example, components for conditioning line frequency AC power to be supplied to stator windings 108 with a desired current, i.e., phase, amplitude, and frequency. Such power electronics may include, for example, and without limitation, one or more rectifier stages, power factor correction (PFC) circuits, filters, transient protection circuits, EMF protection circuits, inverters, or power semiconductors. AC power supply 102 may supply any suitable frequency for a given application, including, for example, 50 Hertz, 60 Hertz, or 400 Hertz, among others. AC power supply 102 may supply any suitable voltage for a given application, including, for example, 100 volts, 110 volts, 200 volts, 220 volts, 300 volts, or 600 volts, among others.

More specifically, motor controller 106 includes a rectification circuit 112, a DC bus 114, and an inverter 116. Rectification circuit 112 converts, or rectifies, supplied AC voltage to a DC voltage to energize DC bus 114. DC bus 114 may operate at any suitable DC voltage, including, for example, 300 VDC, 380 VDC, 480 VDC, 600 VDC, or any other DC voltage suitable for supply to inverter 116. DC bus 114 may also include one or more filter components, passive or active, for conditioning the DC voltage for supply to inverter 116. For example, in certain embodiments, DC bus 114 may include one or more capacitors coupled between positive and negative nodes of DC bus 114 to “smooth” and stabilize the DC bus voltage.

Inverter 116, sometimes referred to as a variable frequency drive, variable speed drive, or variable frequency variable voltage drive, generally includes a plurality of semiconductor switching devices for converting the DC bus voltage to a multi-phase, variable frequency, variable voltage AC power for energizing stator windings 108. The semiconductor switching devices in modern inverters may include, for example, WBG semiconductor switches such as SiC MOSFETs or GaN transistors. Previous generations of inverters utilized silicon-based power MOSFETs or IGBTs. Accordingly, modern inverters, such as inverter 116, can operate at switching frequencies five to ten times greater than with silicon-based devices. For example, in certain embodiments, WBG semiconductors switch at 100 kilohertz (kHz), 50 kHz, 40 kHz, 30 kHz, 20 kHz, 10 kHz, or any other suitable high frequency for WBG devices. Conversely, certain IGBT devices, for example, switch at 10 kHz, 5 kHz, 2.5 kHz, or lower. Operation of inverter 116 and, more specifically, operation of the individual WBG semiconductor switches is controlled by a microcontroller 118.

Microcontroller 118 is an embedded computing system for controlling operation of electric motor drive system 100 and, in particular, inverter 116. Microcontroller 118 includes memory 120 and a processing unit 122. Memory 120 stores one or more programs, applications, firmware, or other software instructions for execution by processing unit 122.

Inverter 116 generates a variable frequency, variable voltage output to energize stator windings 108. Inverter 116 is electrically connected to stator windings 108 by a cable 124 including a plurality of conductors 126. Cable 124 may include, for example, one or more dedicated conductors for each AC phase output from inverter 116. In certain embodiments, motor controller 106 is positioned remotely from stator windings 108 and rotor 110. In other embodiments, motor controller 106 is positioned integral with or adjacent to stator windings 108 and rotor 110. Accordingly, depending on the implementation, the lengths of conductors 126 can vary widely.

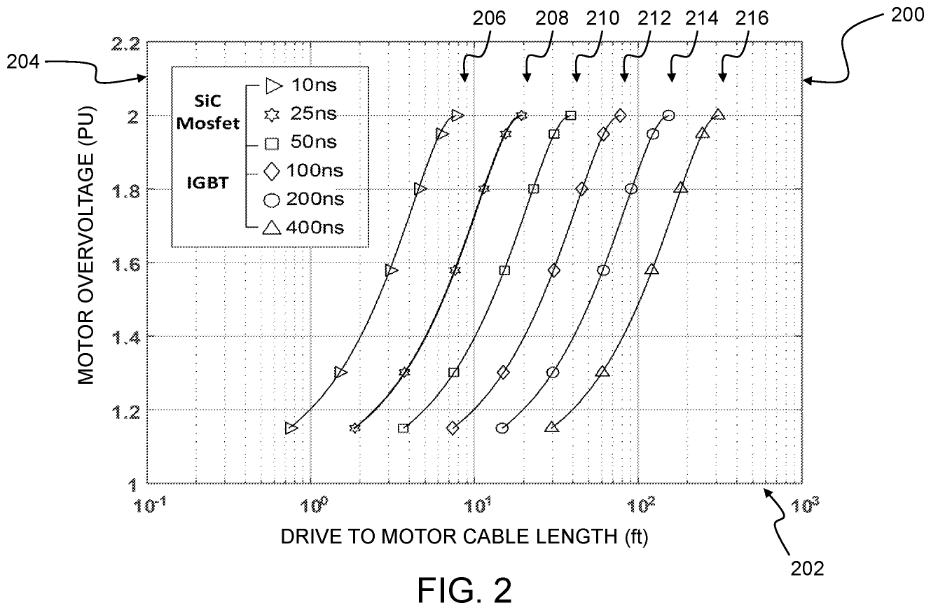

FIG. 2 is a graph 200 illustrating electric motor surge voltage for a range of cable length, or conductor length, between an inverter, such as inverter 116 shown in FIG. 1, and the stator windings, such as stator windings 108 shown in FIG. 1. Graph 200 includes a horizontal axis 202 representing conductor length in feet on a logarithmic scale. Graph 200 includes a vertical axis 204 representing motor voltage, or “overvoltage” or “surge voltage,” in per unit ranging from 1.0 to 2.2.

Graph 200 includes six data series (206, 208, 210, 212, 214, 216) representing surge voltage at increasing switching rise time (from 10 nanoseconds to 400 nanoseconds). The data series generally illustrate an increased surge voltage as cable length increases between the inverter and the stator windings. Data series 206, 208, 210, and 212 illustrate the voltage increase for example switching frequencies achievable with WBG switching devices, e.g., SiC switching devices. Data series 210, 212, 214, and 216 illustrate the voltage increase for example switching frequencies achievable with conventional IGBT switching devices. The data series more generally illustrate as switching frequency increases, a given surge voltage develops with exponentially shorter conductor lengths. Or, in other words, as switching frequency increases, a given cable length will produce greater surge voltages.

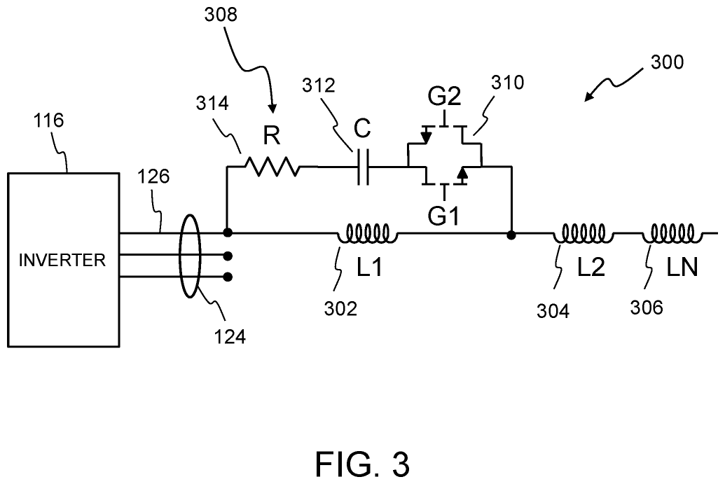

FIG. 3 is a schematic diagram of a stator winding 300 with adaptive impedance circuit. FIG. 3 illustrates inverter 116 coupled to stator winding 300 by cable 124. Stator winding 300 includes a plurality of coils 302, 304, 306 representing portions of stator winding 300 in a single phase to be positioned in distinct stator slots in the stator assembly. Stator winding 300 includes an adaptive impedance circuit 308 connected in parallel with coil 302. Coil 302 is illustrated in FIG. 3 as a first stator slot; however, adaptive impedance circuit 308 may be connected across, i.e., in parallel with, any one stator slot or duplicated in parallel with multiple stator slots, e.g., across coil 302, coil 304, coil 306, and so on. Likewise, adaptive impedance circuit 308 can be included in multiple or all phases of stator winding 300.

Adaptive impedance circuit 308 includes WBG transistors 310 connected in series with a capacitance 312 and resistance 314. Capacitance 312 may include, for example, ceramic capacitors operable at high temperatures, e.g., up to 175 degrees Celsius. WBG transistors 310 may include, for example, GaN or SiC transistors connected in an antiparallel arrangement. When WBG transistors 310 are enabled, or closed or “on,” the impedance of capacitance 312 and resistance 314 are combined in parallel with the inductive impedance of stator winding 300. More specifically, the impedance of stator winding 300 becomes more capacitive when WBG transistors 310 are closed. Conversely, when WBG transistors 310 are opened, the impedance of stator winding 300 is more inductive. In this manner, adaptive impedance circuit 308 adaptively adjusts the winding impedance in real-time. WBG transistors 310 are configured, for example, to close when an overvoltage is detected, in that WBG transistors 310 are controlled by a driver circuit, for example, an analog driver circuit that opens and closes WBG transistors 310 based on a measured voltage, e.g., a voltage measured at the inverter or other variable speed drive output terminals, a voltage measured on cable 124, or a voltage measured at the AC input terminals for stator winding 300. The voltage measurement may be enabled by a voltage measurement circuit, which may include one or more voltage sensors coupled to the inverter, 116, to cable 124, or stator winding 108.

The driver circuit may be configured to enable, i.e., close, adaptive impedance circuit 308 at any predetermined voltage threshold, absolute or relative. For example, the driver circuit may close WBG transistors 310 when a measured voltage on the output terminals of inverter 116 exceeds 600 Volts, 800 Volts, or 1000 Volts. Alternatively, the driver circuit may close WBG transistors 310 when the measured voltage exceeds a multiple of a DC bus voltage supplied to inverter 116. For example, the driver circuit may close WBG transistors 310 when the measured voltage exceeds a maximum voltage such as 1.5× the DC bus voltage. When enabled, adaptive impedance circuit 308 makes coil 302 more capacitive in real time, resulting in a voltage shift from coil 302 to coil 304, coil 306, and so on. The voltage shift at least partially corrects for the uneven distribution of voltage among the coils within a given phase, resulting in more evenly distributed voltage across the coils, and coil voltages within acceptable operating ranges.

The driver circuit for adaptive impedance circuit 308 is energized independent of the stator windings for a given phase. For example, in certain embodiments, the driver circuits may be powered by DC bus 114 or AC power supplied to stator winding 300. The driver circuit may also include a voltage regulation circuit to step-down, for example, the DC bus voltage to a low voltage DC supply for analog components. Alternatively, the driver circuit may be powered by a battery or other external power source.

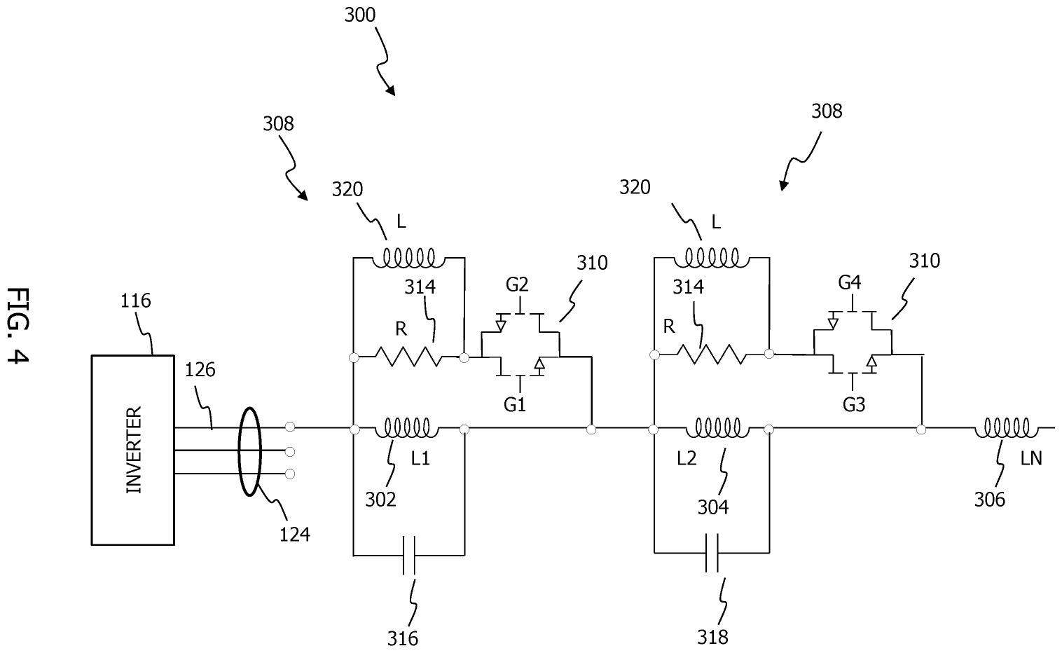

FIG. 4 is a schematic diagram of stator winding 300 with another embodiment of adaptive impedance circuit 308. Stator winding 300 and adaptive impedance circuit 308 depicted in FIG. 4 otherwise operate as described above with respect to the embodiment shown in FIG. 3. In the embodiment shown in FIG. 4, coil 302 and coil 304 include capacitors 316 and 318 connected in parallel with coil 302 and coil 304, respectively, and in parallel with adaptive impedance circuit 308. In the embodiment of FIG. 4, adaptive impedance circuit includes series resistance 314 connected in parallel with a series inductance 320, i.e., series inductance 320 is in series with WBG transistors 310 and in parallel with series resistance 314. When WBG transistors 310 are enabled (i.e., closed), both series resistance 314 and series inductance 320 are active. The capacitance value of parallel capacitors 316 and 318 regulates the relative speed with which voltage rises on coil 302, coil 304, coil 306, and so on. For example, a smaller capacitance on coil 304 (relative to coil 302) results in a faster voltage rise relative to coil 302. Likewise, the voltage rise times on coil 302 and coil 304 indirectly affect the voltage rise time on coil 306. Conversely, a large capacitance value on coil 304 results in a faster voltage rise time on coil 306, potentially resulting in an overvoltage.

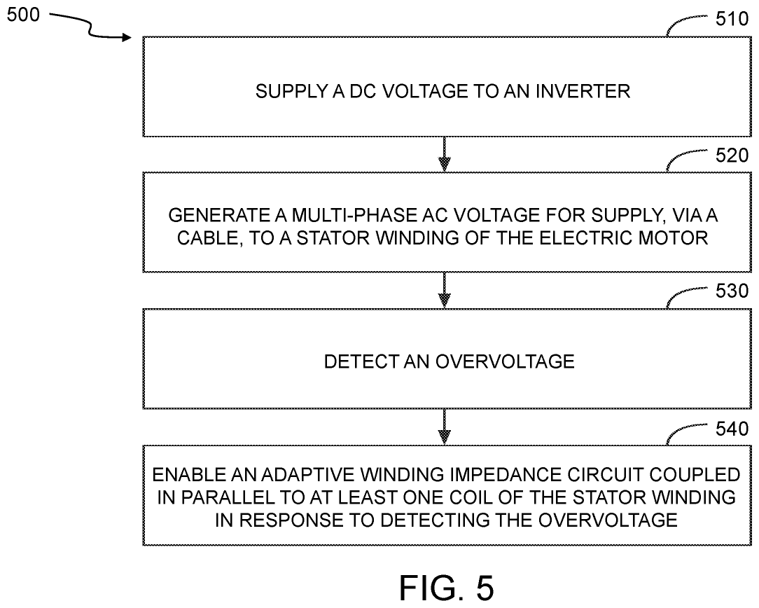

FIG. 5 is a flow diagram of an example method 500 of operating an electric motor, such as electric motor drive system 100 shown in FIG. 1. A DC voltage, for example, the voltage on DC bus 114, is supplied 510 to an inverter, such as inverter 116 or other variable speed drive. Inverter 116 generates 520 a multi-phase AC voltage for supply through cable 124. Inverter 116, for example, includes a plurality of WBG switching devices operating, or switching or commutating, at a switching frequency to produce each phase of the multi-phase AC voltage, including, for example, a first phase, a second, phase, and so on. The switching frequency, enabled by inclusion of WBG switching devices, is at least 10 kHz. In alternative embodiments, the switching frequency may be in a range of 10 kHz to 100 kHz. In some embodiments, the switching frequency may exceed 100 kHz.

Cable 124 connects inverter 116 to the multiple phases of stator winding 108. When the multi-phase AC voltage is supplied to stator winding 108, energizing stator winding 108, stator winding 108 electromagnetically couples to rotor 110 and causes rotor 110 to turn.

During operation, due to inherent impedance mismatching and conductors spanning long lengths, reflected voltage waves develop causing the development of excessive voltage at inverter 116, on cable 124, or on stator winding 108. The overvoltage is detected 530, e.g., by a voltage sensor at inverter 116, on cable 124, or on stator winding 108. Upon detection, adaptive impedance circuit 308 is enabled 540. Adaptive impedance circuit 308 is connected in parallel to at least one coil of stator winding 108, e.g., coil 302 shown in FIG. 3, and dynamically adjusts the impedance of stator winding 108 in real-time in response to the detected overvoltage.

The methods and systems described herein may be implemented using computer programming or engineering techniques including computer software, firmware, hardware or any combination or subset thereof, wherein the technical effect may include at least one of: (a) enabling dynamic adjustment of winding impedance during operation in real-time; (b) mitigating voltage surges at the output of inverters, on cables, and on the stator windings for electric motors; (c) reducing losses associated with high frequency switching devices in variable speed drives; (d) improving power density associated with high frequency switching devices in variable speed drives; (e) extending useful life of components of electric motors, including insulation on stator windings; and (f) eliminating bulky passive components otherwise required for mitigating surge voltages.

In the foregoing specification and the claims that follow, a number of terms are referenced that have the following meanings.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here, and throughout the specification and claims, range limitations may be combined or interchanged. Such ranges are identified and include all the sub-ranges contained therein unless context or language indicates otherwise.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processor, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processing (DSP) device, an application specific integrated circuit (ASIC), and other programmable circuits or processing devices capable of executing the functions described herein, and these terms are used interchangeably herein. The above embodiments are examples only, and thus are not intended to limit in any way the definition or meaning of the terms processor, processing device, and related terms.

In the embodiments described herein, memory may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROMs, DVDs, and any other digital source such as a network or the Internet, as well as yet to be developed digital means, with the sole exception being a transitory, propagating signal. Alternatively, a floppy disk, a compact disc-read only memory (CD-ROM), a magneto-optical disk (MOD), a digital versatile disc (DVD), or any other computer-based device implemented in any method or technology for short-term and long-term storage of information, such as, computer-readable instructions, data structures, program modules and sub-modules, or other data may also be used. Therefore, the methods described herein may be encoded as executable instructions, e.g., “software” and “firmware,” embodied in a non-transitory computer-readable medium. Further, as used herein, the terms “software” and “firmware” are interchangeable, and include any computer program stored in memory for execution by personal computers, workstations, clients and servers. Such instructions, when executed by a processor, cause the processor to perform at least a portion of the methods described herein.

Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

The systems and methods described herein are not limited to the specific embodiments described herein, but rather, components of the systems and/or steps of the methods may be utilized independently and separately from other components and/or steps described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An electric motor drive system, comprising:
a rotor configured to be coupled to a mechanical load;
a stator winding configured, when energized, to cause the rotor to turn, the stator winding including:
a first inductive coil of a plurality of coils in a first phase, the first inductive coil configured to be energized with a first phase alternating current (AC) voltage; and
an adaptive impedance circuit connected in parallel with the first inductive coil, the adaptive impedance circuit comprising:
an impedance; and
a wide bandgap (WBG) transistor connected in series with the impedance, wherein the WBG transistor is configured to close when an overvoltage is detected;
a cable comprising at least one conductor connected to the stator winding; and
a motor controller configured to supply a multi-phase AC voltage to the stator winding through the cable.

2. The electric motor drive system of claim 1, wherein the impedance comprises a series capacitance and a series resistance.

3. The electric motor drive system of claim 1, wherein the motor controller comprises an inverter configured to generate a variable frequency multi-phase AC voltage.

4. The electric motor drive system of claim 3, wherein the inverter comprises a plurality of WBG switching devices operable at a switching frequency of at least 10 kilohertz.

5. The electric motor drive system of claim 4, wherein the plurality of WBG switching devices comprises a plurality of Gallium Nitride (GaN) transistors or Silicon Carbide (SiC) transistors.

6. The electric motor drive system of claim 1, wherein the adaptive impedance circuit further includes a voltage sensor configured to measure the overvoltage at output terminals of the motor controller.

7. The electric motor drive system of claim 1, wherein the adaptive impedance circuit is configured to receive an analog drive signal at a gate of the WBG transistor.

8. The electric motor drive system of claim 1, wherein the adaptive impedance circuit is positioned in a first stator slot for the first phase.

9. The electric motor drive system of claim 1, wherein the stator winding further includes a parallel capacitance coupled in parallel to the inductive coil and in parallel to the adaptive impedance circuit, the parallel capacitance configured to regulate voltage distribution among a plurality of inductive coils of the stator winding, including the inductive coil.

10. The electric motor drive system of claim 9, wherein the impedance comprises a series inductance in parallel with a series resistance.

11. The electric motor drive system of claim 1, wherein the stator winding further includes:
a second inductive coil configured to be energized with the first phase AC voltage; and
a second adaptive impedance circuit connected in parallel with the second inductive coil, the second adaptive impedance circuit comprising:
a second impedance; and
a second WBG transistor connected in series with the second impedance, wherein the second WBG transistor is configured to close when an overvoltage is detected in the second inductive coil.

12. An adaptive impedance circuit for connection to at least one inductive coil of a stator winding for an electric motor, the adaptive impedance circuit comprising:
an impedance including at least a capacitance; and
a first wide bandgap (WBG) transistor connected in series with the impedance, wherein the WBG transistor is configured to close when an overvoltage is detected;
wherein, closing the first WBG transistor connects the impedance in parallel to the at least one inductive coil.

13. The adaptive impedance circuit of claim 12 further comprising a second WBG transistor connected in antiparallel with the first WBG transistor.

14. The adaptive impedance circuit of claim 13, wherein the first WBG transistor comprises a Gallium Nitride (GaN) transistor.

15. The adaptive impedance circuit of claim 12, wherein the first WBG transistor is configured to receive, at a gate thereof, an analog driver signal.

16. The adaptive impedance circuit of claim 12, wherein the impedance comprises at least one ceramic capacitor.

17. The adaptive impedance circuit of claim 12 further comprising a driver circuit comprising:
a voltage measurement circuit coupled to the electric motor; and
an analog gate driver connects to the voltage measurement circuit and configured to supply an analog driver signal to the first WBG transistor when the voltage measurement circuit detects the overvoltage.

18. A method of operating an electric motor, said method comprising:
supplying a direct current (DC) voltage to an inverter;
generating a multi-phase alternating current (AC) voltage for supply, via a cable, to a stator winding of the electric motor, thereby electromagnetically coupling the stator winding to a rotor and causing the rotor to turn;
detecting an overvoltage; and
enabling an adaptive impedance circuit connected in parallel to at least one coil of the stator winding in response to detecting the overvoltage.

19. The method of claim 18, wherein generating the multi-phase AC voltage comprises commutating a plurality of wide bandgap (WBG) switching devices at a switching frequency to produce at least a first phase AC voltage.

20. The method of claim 19, wherein the switching frequency is at least 10 kilohertz.

21. The method of claim 19, wherein detecting an overvoltage comprises detecting the overvoltage at an output of the inverter.

22. The method of claim 18, wherein enabling the adaptive impedance circuit comprises closing a wide bandgap (WBG) transistor connected in series with an impedance.

23. The method of claim 22, wherein enabling the adaptive impedance circuit comprises closing a pair of WBG transistors connected in antiparallel, and wherein the impedance includes at least a capacitance.
